(19) United States
(12) Patent Application Publication
(10) Pub. No.: US 2015/0294662 A1
(43) Pub. Date: Oct. 15, 2015

(54) Selective Noise-Cancelling Earphone

(71) Applicant: Ahmed Ibrahim, Rochester, NY (US)

(72) Inventor: Ahmed Ibrahim, Rochester, NY (US)

(21) Appl. No.: 14/685,566

(22) Filed: Apr. 13, 2015

Related U.S. Application Data
(60) Provisional application No. 61/978,308, filed on Apr. 11, 2014.

(51) Int. Cl. G10K 11/175

(52) U.S. Cl. CPC G10K 11/175; G10K 2210/1081

(57) ABSTRACT

An earphone adapted to fit within a human ear that generates sound via the propagation of one or more diaphragms aligned to fit the structure and shape of the earphone. The earphone allows ambient sound to pass through the device in order to be heard by the user. The earphone includes a variety of sensors adapted to characterize the surrounding acoustic environment and actively negate undesired sounds by generating a cancelling signal specific to the undesired sound or sounds. The earphone allows users to select particular sounds to cancel or to negate all of the surrounding noise. The earphone itself can be used to characterize repetitive environmental sounds that are predictable by the system. Additionally, the earphone can be used in conjunction with a buffering device in communication with a source of non-repetitive, unpredictable sounds in order to characterize and negate those sounds.

### CROSS REFERENCE TO RELATED APPLICATION

This application claims the benefit of U.S. Provisional Application No. 61/978,308 filed on Apr. 11, 2014. The above identified patent application is herein incorporated by reference in its entirety to provide continuity of disclosure.

### FIELD OF THE INVENTION

The present invention relates to an earphone device. More specifically, the present invention relates to earphone systems that employ active noise-cancellation.

### BACKGROUND OF THE INVENTION

Headphones or earphones, which are headphones that fit within a user's ear, allow users to listen to music or other sounds that are electrically transmitted from attached devices. Standard earphones do not adequately filter out ambient environmental noise. User's wearing standard earphones must raise the volume of the sound to overcome the environmental noise, which may cause damage to the eardrum over extended periods of use.

Passive noise-cancelling earphones exist in the prior art. These devices create a seal between a user's ear canal and the speaker portion of the earphone device, which forms a physical barrier that blocks ambient noise from also entering the ear canal. One drawback of passive noise-cancelling earphones is that the shape of the earphone and tight fit needed to form a physical barrier may result in discomfort for the user. Also, passive noise-cancelling earphones do not allow users to select particular ambient sounds to block out and instead block out all environmental noise. Particular ambient sounds, such as sirens or alarms, serve as important cues that convey information about the surrounding environment. It is important for a user to be able to hear these ambient sounds so that they may react accordingly. Therefore, it is desirable to provide a noise-cancelling earphone that may fit comfortably within a user's ear and be utilized to selectively cancel ambient environmental noise.

Active noise control is generally achieved using digital signal processing. Once a noise signal is characterized by the device, the earphone then emits a sound wave with the same amplitude but with inverted phase. The two “opposite” sound waves destructively interfere with one another, effectively reducing the volume of the ambient noise. One drawback to this method is that it does not allow a user to choose whether particular sounds should be cancelled or be heard. Therefore, a noise-cancellation earphone that allows users to configure the mode of operation and cause the noise-cancellation circuitry to bypass a particular sound or frequency and create a resultant wave that interferes with the first wave, cancelling the undesired sound, is needed.

Active noise-cancelling earphones that allow users to filter out environmental noise without increasing the volume of the sound emitted by the device attached to the earphones exist in the prior art. Current active noise-cancelling earphones utilize a feed forward active noise-cancellation configuration. This type of system measures ambient noise directly outside the earphone's seal against the inner ear using a microphone transducer and then generates a corresponding reference signal. The reference signal is then processed by active noise-cancellation electronic circuitry and emitted as a cancelling sound waveform that effectively cancels out the ambient noise. One drawback with this type of active noise-cancellation is that only the aggregate noise as analyzed at the seal between the earphone and the user's ear is cancelled. Users are therefore unable to select particular distinct sounds to be cancelled or to bypass the cancellation system. It is therefore desirable to provide a noise-cancelling earphone that allows users to select particular sounds to be filtered out by the noise-cancellation circuitry.

Currently, there are no prior art devices that allow a user to filter out more complex non-repetitive sounds from external noise sources such as televisions or radios. For example, a user may wish to listen for environmental cues but not be distracted by a television sound that someone else is listening to. Current noise-cancelling earphones do not allow this kind of selectivity. Therefore, it is necessary to provide an earphone that utilizes buffer system to pre-characterize the sound signal before it is emitted from the external device, and then emit a corresponding cancel signal at the same time the original signal is emitted from the external device, effectively negating the original sound only for the earphone wearer.

In view of the deficiencies of noise-cancellation earphones in the prior art, there is a need for an active noise-cancelling earphone that allows users to customize their personal acoustic environment. Such a device utilizes multiple sensors to characterize the user's surrounding auditory environment such as directional microphones. Users may use the device to record particular sounds they wish to cancel, such as the hum of an appliance such as a refrigerator, and store the recorded sounds on the device. The device then actively monitors the surrounding environment and characterizes the ambient noise.

Therefore, it is desirable to provide an earphone system that allows the user to select from a database of particular sounds and a choose whether to allow those sounds to be heard while also listening to sounds provided by an external sound source such as a music player.

### SUMMARY OF THE INVENTION

In view of the foregoing disadvantages inherent in the known types of noise-cancelling earphones or headphones now present in the prior art, the present invention provides a selective noise-cancelling earphone wherein the same can be utilized for providing convenience for the user when seeking to remove particular sounds from the environment, while leaving the remaining environmental sounds unaffected. The present system comprises an earphone adapted to fit within a human ear that generates sound via the propagation of one or more diaphragms aligned to fit the structure and shape of the earphone. The earphone allows ambient sound to pass through the device in order to be heard by the user. The earphone includes a variety of sensors adapted to characterize the surrounding acoustic environment and actively negate undesired sounds by generating a canceling signal specific to the undesired sound or sounds. The earphone allows users to select particular sounds to cancel or to negate all of the surrounding noise.

The earphone itself can be used to characterize repetitive environmental sounds that are predictable by the system. In an illustrative embodiment of the present invention, the earphone can be set into a listening mode wherein it monitors the environment for a high frequency, repetitive sound. When such a sound is detected, the earphone can save the characterized waveform for the sound either locally or to a distributed or cloud-based network for later access. With the characterized waveform for the sound saved, the earphone can then generate a cancelling signal for the characterized sound whenever the characterized sound is detected by the system. Additionally, the earphone can be used in conjunction with a buffering device in communication with a source of non-repetitive, unpredictable sounds in order to characterize and negate those sounds. When activated, the buffering device pre-characterizes the sound signal to be emitted from a non-repetitive sound source, e.g. a television, and then transmits the characterized sound signal to the earphone so that the earphone can generate an appropriate cancelling signal. Therefore, the present system can be utilized to selectively cancel individual sounds from the environment, leaving the remaining sounds unaffected and thus not affect the user's ability to hear those unaffected sounds.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a view of an earphone according to the present invention placed within a user's ear.

FIG. 2 shows a flowchart of a first mode of operation of the present.

FIG. 3 shows a diagram of the electronic components of an earphone according to the present invention.

FIG. 4 shows a flowchart of a second mode of operation of the present invention.

FIG. 5 shows a flowchart of a third mode of operation of the present invention.

FIG. 6 shows a flowchart of a fourth mode of operation of the present invention.

### DETAILED DESCRIPTION OF THE INVENTION

Reference is made herein to the attached drawings. Like reference numerals are used throughout the drawings to depict like or similar elements of the selective noise-cancelling earphone. For the purposes of presenting a brief and clear description of the present invention, the preferred embodiment will be discussed as used for allowing individuals to listen to music while simultaneously allowing them to listen to their surrounding environment and/or selectively eliminate particular sounds from the environment that the user does not wish to hear. The figures are intended for representative purposes only and should not be considered to be limiting in any respect.

As used herein, “logic” refers to (i) logic implemented as computer instructions and/or data within one or more computer processes and/or (ii) logic implemented in electronic circuitry. As used herein, “computer-readable medium” excludes any transitory signals, but includes any non-transitory data storage circuitry, e.g., buffers, cache, and queues, within transceivers of transitory signals.

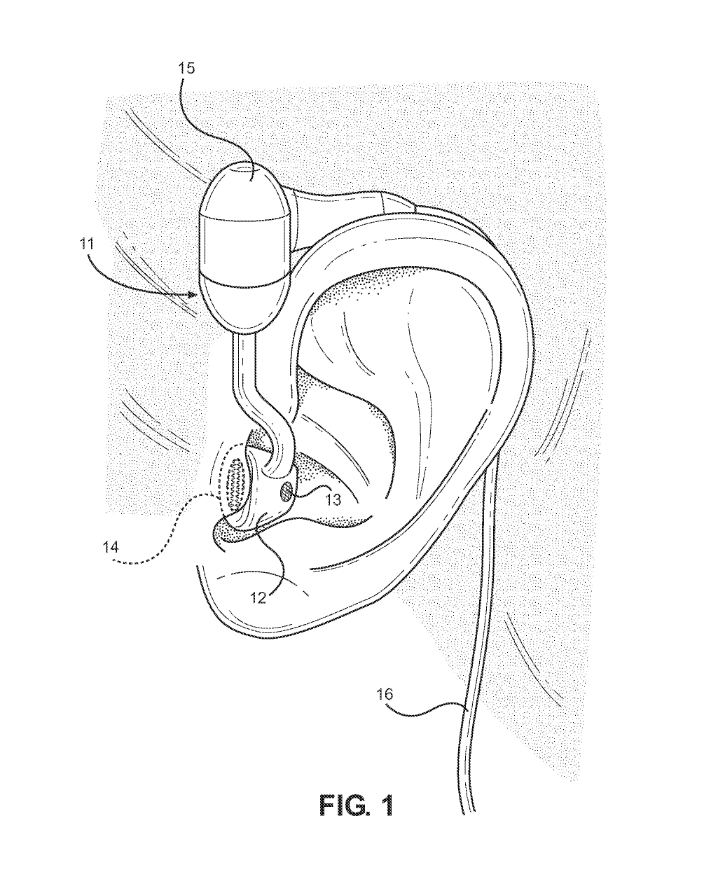

Referring now to FIG. 1, there is shown a view of an earphone according to the present invention placed within a user's ear. The present invention comprises an earphone 11. As with conventional earphones, the present earphone 11 is connectable to an external device and emits a stereo signal therefrom via a connector 16. In the illustrative embodiment of the present invention, the connector 16 comprises a conventional cord with an electrical connector. In other embodiments of the present invention, the connector 16 comprises a wireless connector, such as a wireless transceiver utilizing the Bluetooth wireless connection protocol. The earphone 11 comprises any suitable shape that provides comfort and secure fit when placed within a user's ear. In the depicted embodiment of the present invention, the earphone 12 comprises a body 12 sized and shaped to rest within the external auditory portion of a user's ear canal, while still allowing external sound to reach the user's ear canal. This illustrative embodiment of the present invention further comprises a microphone 13 disposed on the surface of the body 12 external to the user's ear canal and a speaker 14 disposed on the surface of the body 12 interior to the user's ear canal. Although the present invention is discussed as having a microphone 13 and a speaker 14, it should be understand that alternative embodiments of the present invention utilizing multiple microphones 13 and/or multiple speakers 14 are contemplated and the present disclosure should not be read as limited to embodiments having a single microphone 13 or a single speaker 14. The microphone 13 receives sound from the environment and the speaker 14 emits one or more cancelling signals corresponding to one or more sounds stored in the memory of the earphone 11.

In one embodiment of the present invention, the processor, power source, and various other electronic components of the present invention are housed within a secondary body 15, or a speaker driver, separated from the body 12 adapted to fit within the user's ear. Distributing one or more of the electronic components of the present invention into the secondary body 15 allows for the number of electronic components disposed within the body 12 to be minimized, thereby allowing the size and shape of the body 12 to be adapted for comfortable placement within the external auditory portion of an ear canal without competing design concerns. In another embodiment of the present invention, the processor, power source, and other electronic components of the present invention are housed within the body 12.

If the noise-cancelling system is activated, the microphone 13 is in electrical communication with a logic, which analyzes the sound received from the microphone 13, separates the sound into a plurality of distinct sound waveforms, compares the separated sounds against a library stored in the memory containing one or more sound waveforms that the user wishes to not hear, and then emits one or more cancelling signals to cancel the desired sounds. The cancelling signals are then emitted for the user to hear via the speaker 14, which is in electrical communication with the logic, disposed within or adjacent to the user's ear canal. If the noise-cancelling system is not activated, then the ambient sound enters the user's ear without a cancelling signal removing specified sounds from the environment, allowing the user to perceive the unadulterated environmental sound without interference from the present system.

In the illustrative embodiment of the present invention, the sound is allowed to directly enter the user's ear canal, through one or more channels disposed through the earphone, and one or more inwardly-directed speakers 14 emit noise-cancelling signals to selectively cancel particular sounds characterized by the logic. In this alternative embodiment of the present invention, the present system comprises a body 12 comprising one or more channels therethrough that allow for ambient environmental sound to be pass directly therethrough to a user's ear canal. In this embodiment of the present invention, when the system is in noise-cancelling mode, the logic monitors the ambient environmental sound received via the microphone 13 for pre-characterized sound waveforms stored within the memory. If one of the pre-characterized sound waveforms is detected by the system, then the one or more speakers 14 disposed on the interior surface of the body 12 emit a cancelling sound signal that cancels the particular characterized sound via destructive interference, or another such active noise-cancelling method.

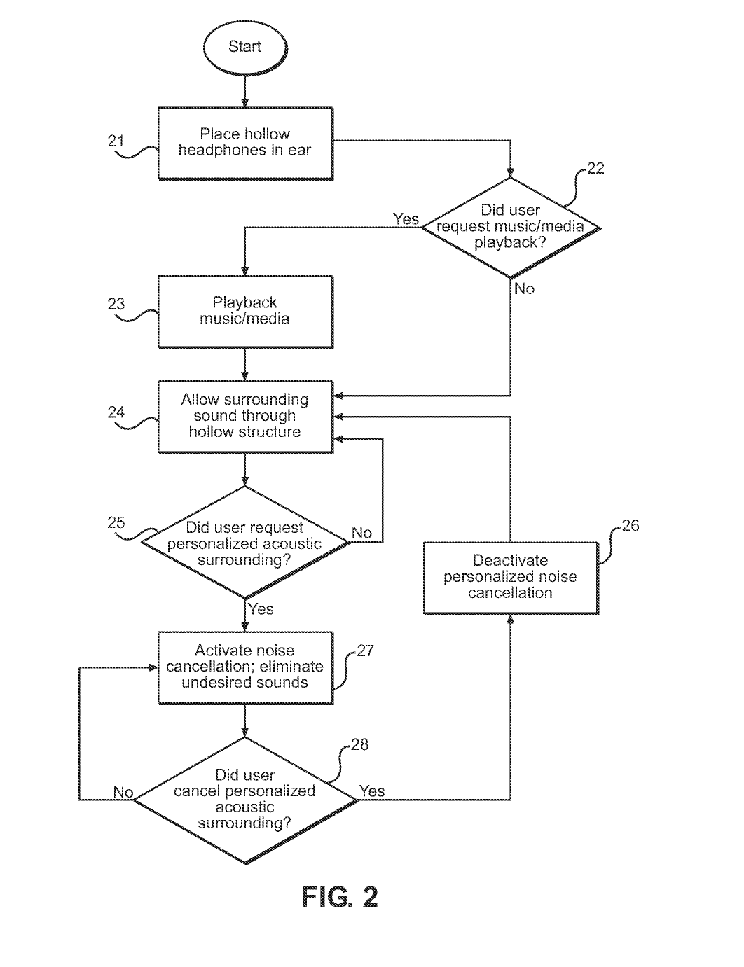

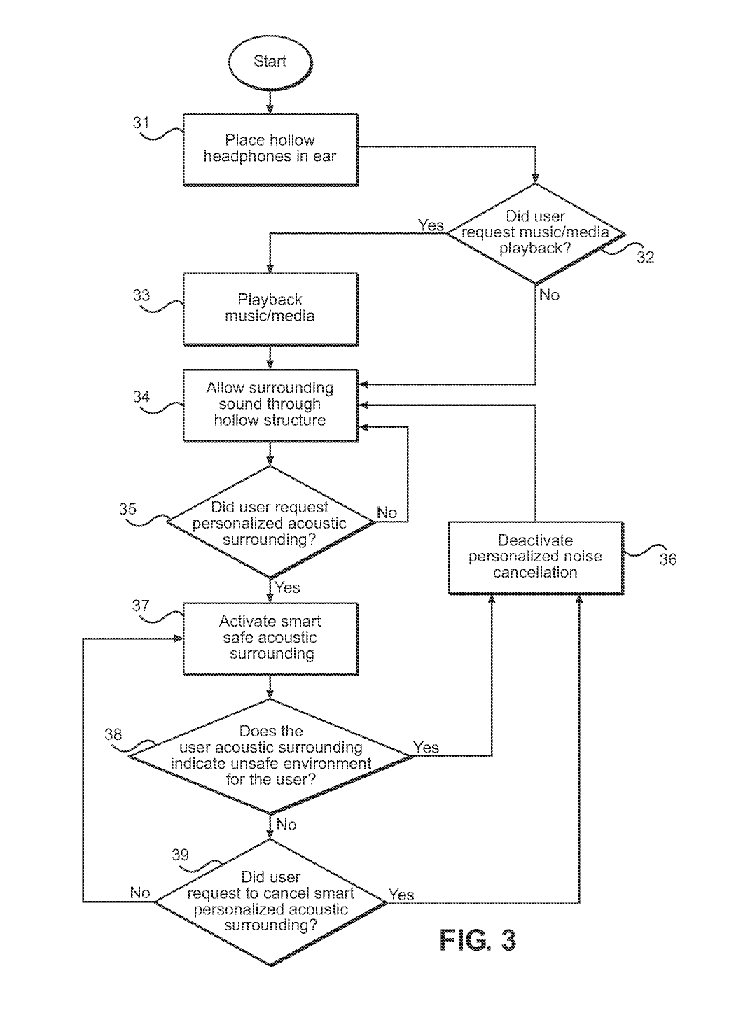

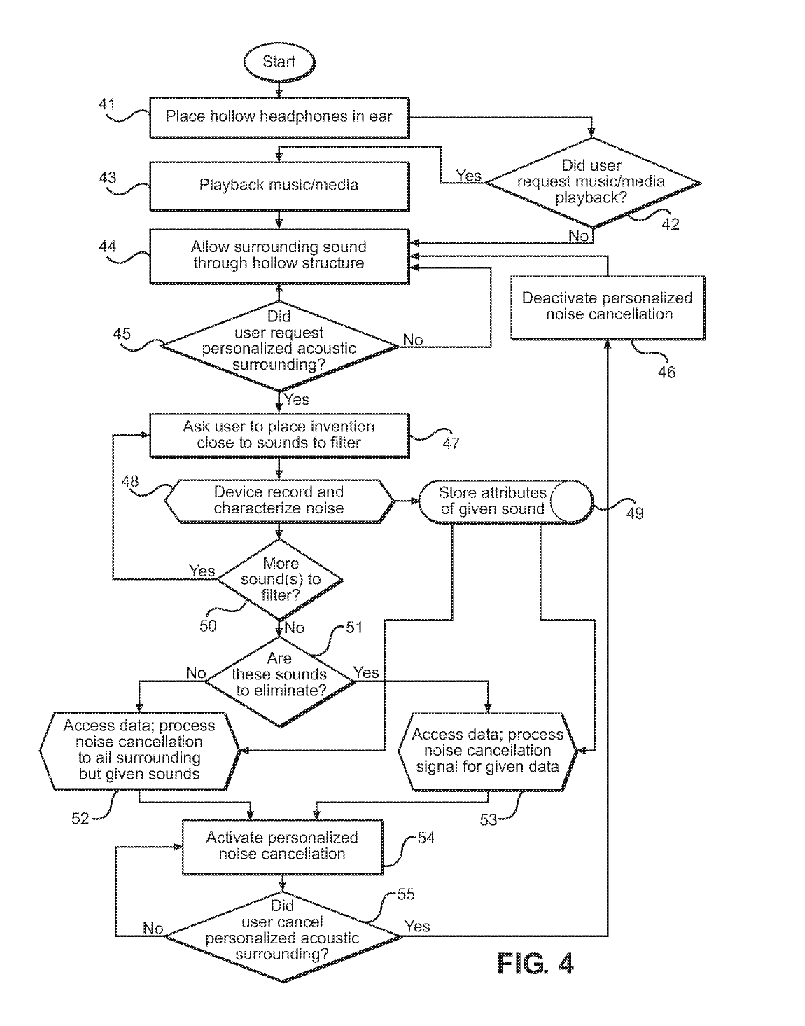

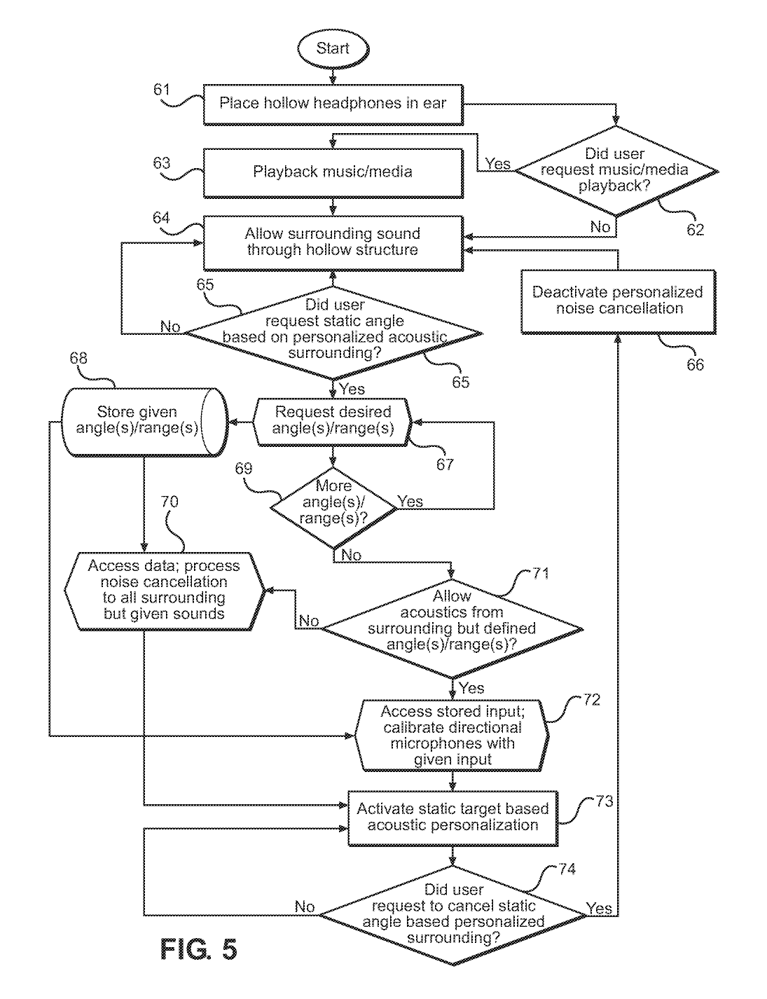

Referring now to FIGS. 2-5, there are shown flowcharts of various modes of operation of the present invention. The flowchart depicted in FIG. 1 represents a basic mode of operation for the present invention. The present invention is utilized by placing the earphone within the user's ear 21. If the user has initiated music playback 22 on the external sound source, which comprises an mp3 player, a cell phone, or another such electronic device, then the music playback is initiated 23 through the earphone and the environmental sound is also permitted through the body of the earphone 24, subject to cancelling sound signals if the user has activated the personalized acoustic setting. If the user has not initiated music playback 22, then the environmental sound is simply permitted through the body of the earphone without the corresponding overlay of music playback, subject to cancelling sound signals if the user has activated the personalized acoustic setting.

Prior to the music playback and/or environmental sound being emitted to the user via the speaker, the system checks 25 to see whether the user has activated the personalized acoustic setting 27, i.e. active noise-cancellation for particular sounds selected by the user. If the user has activated the active environmental noise-cancellation 27, then the environmental sound received via the microphone undergoes processing to dissect the environmental sound into a plurality of particularized sounds. The dissected particularized sounds are then compared against a library of sounds stored within the memory. If the particularized sound waveforms match a corresponding waveform stored within the memory, then the logic initiates the speakers to emit a cancelling signal to selectively remove that characterized sound waveform from the environmental sound heard by the user via destructive interference or another such active noise-cancelling method. If the user thereafter cancels 28 the personalized acoustic surrounding, then the system deactivates the active noise-cancellation 26 and the full, unadulterated environmental sound reaches the user's ear canal.

In one embodiment of the present invention, the earphone comprises a recording mechanism, which allows users to record particular sounds they wish to filter out via the active noise-cancellation function of the earphone. A user may record a particular ambient sound source, e.g. the hum of a refrigerator, dishwasher, or another such appliance, using a microphone disposed on the earphone body. The recording is then stored in an internal memory within the earphone. Thereafter, if the noise-cancellation feature is activated by the user, the logic monitors the environmental sound received via the microphone for an occurrence of that particular characterized sound. If the device detects a waveform matching the waveform for a characterized, stored sound, the logic emits a signal to cancel out the particular sound from the overall environmental sound received via the microphone. The cancelling signal is generated with the same amplitude as the sound to be cancelled and a phase shift so that the two sounds destructively interfere with each other, resulting in the particular sound not being heard by the user.

In another embodiment of the present invention, the memory comprises one or more pre-installed sound waveforms corresponding to commonly-encountered repetitive sounds. For example, emergency service vehicle sirens and building alarms generate a distinctive repeating waveform. When the microphone detects a noise or auditory environmental cue that corresponds with a stored frequency pattern, such as a pattern corresponding to a siren, the device automatically lowers the volume of the playback from the external connected device so that a user can hear the environmental cue via. Alternatively, a user may cease the noise-cancellation function at any time. In one operating mode, the device actively monitors for such sounds when ambient noise-cancellation is active. If the device detects a particular sound corresponding to the recorded environmental warning sound, the device interrupts the noise-cancellation function so that the auditory environmental cue may be clearly heard by the user.

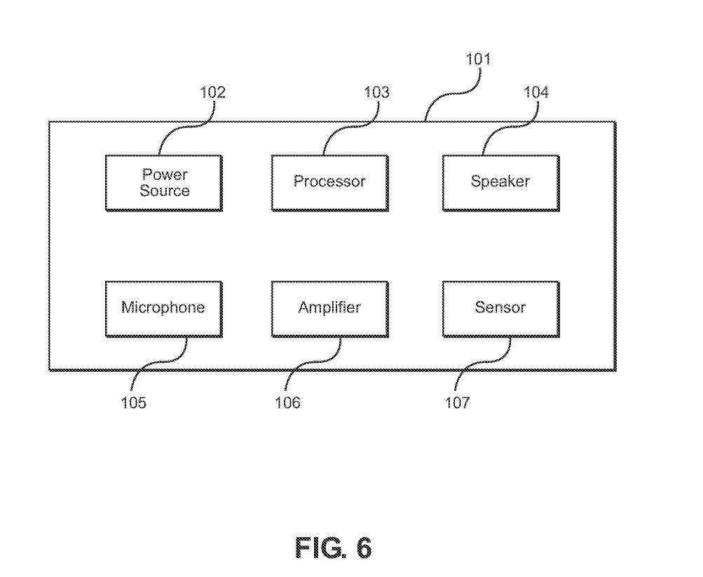

Referring now to FIG. 6, there is shown a diagram of the electronic components of an earphone according to the present invention. An illustrative embodiment of the earphone 101 comprises a power source 102, a processor 103 that executes the logic controlling the function of the noise-cancellation system, a speaker 104 disposed on the exterior surface of the earphone 101 such that it is directed inwardly towards the user's ear canal when the earphone is worn by a user, an audio sensor, such as a microphone 105, disposed on the exterior surface of the earphone 101 such that it is directed outwardly towards the surrounding environment when the earphone is worn by a user, an amplifier 106, and a non-transitory computer readable medium, such as a memory 108, on which the logic and the characterized sound waveforms are stored. All of the various electronic components of the earphone 101 are in electrical communication. Alternative embodiments of the present invention further comprise an electrical cord for directly connecting the earphone 101 to an external electronic device, a wireless transceiver for wirelessly connecting the earphone 101 to an external electronic device, or another such connector 107. No claim is made as to the precise connector utilizes by the present invention.

The logic executed by a processor 103 comprises a variety of different functions. When the active noise-cancellation system is activated, the logic dissects the environmental sound received by the microphone 105 into distinct waveforms for each particular sound contained within the environment, allowing the logic to characterize each of these sounds and compare it against the one or more stored sound waveforms held on the memory 108. If the characterized waveform matches a stored waveform and the user has activated the noise-cancellation system, then the logic generates an appropriate cancelling signal having an amplitude equal to the amplitude of the characterized sound to be cancelled. The cancelling signal is then emitted by a speaker 104. In one embodiment of the logic, the cancelling signal is a phase-shifted waveform corresponding to the waveform of the sound to be cancelled, destructively interfering with the isolated environmental sound and thereby removing it from the overall canvas of environmental sound received through the microphone 105.

For non-repeating environmental sounds, such as those that are typically emitted from television, a single recording will not suffice. One embodiment of the invention provides a buffer system that attaches to an external ambient noise source, such as a television. In this example, the sound data will first travel through the buffer system which characterizes the waveform of the sound before allowing it to be emitted from the device. The characterized waveform is then used to generate a cancel signal, which is then sent to the earphone. The buffer system controls the output of the external device so that the cancel signal is emitted as a sound in via the earphone at the same time the sound is emitted from the television. This mode of operation provides the ability to selectively cancel noise from particular sources. For instance, if a user wishes to be able to hear his or her surrounding environment but does not want to hear the noise from a television. In this example, the buffer system filters the television noise from the user's ambient environment, and the rest of the ambient environment is then audible to the user.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A noise-cancelling earphone comprising:
a rigid body adapted to fit within an ear of a user;
an amplifier;
a connector adapted to connect the amplifier to an external sound source;
a cancel signal generator;
a speaker adapted to output an audio signal from the external sound source and a cancel signal from the cancel signal generator;
one or more sensors adapted to measure ambient noise from one or more ambient noise sources;
a recording mechanism for recording and storing the ambient noise;
one or more processors;
a non-transitory computer readable medium operatively connected to the one or more processors;
a logic stored in the non-transitory computer readable medium that, when executed by the one or more processors, causes the noise-cancelling earphone to control the volume of the ambient noise by at least:
initiating the recording of ambient noise via the recording mechanism;
recognizing a distinct sound waveform having a first amplitude in an ambient environment;
generating a cancel signal via the cancel signal generator; wherein the cancel signal has the first amplitude;
emitting the cancel signal through the speaker.

2. The noise-cancelling earphone of claim 1, wherein the logic stored in the non-transitory computer readable medium is further configured to cause the noise-cancelling earphone to control the volume of ambient noise by at least:
determining if the ambient noise exceeds a threshold value;
if the ambient noise exceeds the threshold value, then emitting the cancel signal to cancel the sound via the speaker, wherein the cancel signal has an amplitude equal to the first amplitude.

3. The noise-cancelling earphone of claim 1, wherein the connector comprises an audio input jack adapted to receive an auxiliary cable physically connected to the external sound source.

4. The noise-cancelling earphone of claim 1, wherein the connector comprises a wireless transceiver adapted to receive a signal wirelessly transmitted from the external sound source.

5. The noise-cancelling earphone of claim 1, wherein the earphone further comprises a switch for selecting between a first mode of operation wherein the user selects between one of either supplying no sound to the user with no active ambient noise reduction, supplying sound from the external source to the user with active ambient noise reduction, supplying sound from the external source with no active ambient noise reduction, or supplying no sound from the external source with active ambient noise reduction.

6. A method for cancelling ambient noise comprising the steps of:
recording an ambient sound having a first amplitude via an earphone comprising an external microphone, a speaker, a cancel signal generator, and a computer readable storage;
storing the sound on the computer readable storage;
actively monitoring the environment for the sound via an earphone comprising an external microphone;
generating a cancel signal via the cancel signal generator, wherein the cancel signal has an amplitude equal to the first amplitude; and
emitting the cancel signal via the speaker.

7. A noise reduction system comprising
a noise reducing earphone comprising an amplifier, a speaker, a connector and a buffer system, wherein the connector is configured to connect the earphone to the buffer system;
the buffer system being connectable to an external sound source, the buffer system comprising:
one or more processors;
a non-transitory computer readable medium operatively connected to the one or more processors;
a logic stored in the non-transitory computer readable medium that, when executed by the one or more processors, causes the noise-cancelling earphone to control the volume of the ambient noise by at least:
characterizing the origin signal emitted from the external sound source by determining the amplitude and frequency of the origin signal;
generating a cancel signal having an amplitude equal to the amplitude of the origin signal; and
emitting the cancel signal through the speaker of the noise-cancelling earphone.
